(19) United States
(12) Patent Application Publication
(10) Pub. No.: US 2008/0195001 A1
(43) Pub. Date: Aug. 14, 2008

(54) APPARATUS AND METHOD FOR RELIEVING SINUS PAIN

(76) Inventor: Whitney Werner, Paradise, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 12/015,397

(22) Filed: Jan. 16, 2008

Related U.S. Application Data
(60) Provisional application No. 60/885,289, filed on Jan. 17, 2007.

(51) Int. Cl. A61H 1/00

(52) U.S. Cl. 601/2; 601/46; 601/15

(57) ABSTRACT

An apparatus for relieving sinus discomfort includes a motor for developing vibrational energy and an applicator for applying the vibrational energy to a user's face. A method of relieving sinus discomfort includes applying vibrational energy adjacent the afflicted sinus cavity and may include doing so while the head is generally horizontal to promote drainage of the afflicted sinus cavity.

### RELATED APPLICATIONS

The present application claims the benefit of U.S. Provisional Application Ser. No. 60/885,289, filed Jan. 17, 2007, which is hereby incorporated by reference in its entirety.

### BACKGROUND OF THE INVENTION

1. The Field of the Invention

The present invention relates to an apparatus and method for relieving sinus pain. More particularly, the present invention relates to a device which is applied to the face of a person in order to relieve pain or discomfort caused by congested sinuses.

2. State of the Art

Each year millions of people suffer from sinus pain. The causes of sinus pain are many fold. For some individuals sinus pain is caused when they contract a sinus infection in which bacteria irritate the sinus cavities. The bacterial infection causes the sinuses to create an excess production of mucus in the sinus cavities. The mucus can cause further pressure and swelling and create significant pain and discomfort.

For some people, the sinus pain is so great and the occurrence of sinus infections so frequent that surgery is performed to form additional outlets in the sinuses to improve drainage. This often involves boring through bone or other tissue and can be very painful.

Yet other individuals suffer from sinus pain due to allergies. For many people who are allergic to pollen or dust, one symptom of the allergy is the irritation of the sinus cavities. Generally it includes swelling of the sinus membranes and, for many people, congestion as the sinuses create secretions attempting to flush out the allergens. As the congestion builds, so does the discomfort.

Still others have sinus pain caused by sinus congestion related to the common cold or flu. Likewise, many of these people have secretions in the sinus cavities which fill up and cause discomfort. Sinus pain can often last for days and can be somewhat debilitating. The pressure on the eyes and other parts of the head can, at times, feel unbearable. Thus, many individuals are forced to miss work and/or to take medications which can interfere with attention, sleep, or many other activities. While medications will work in some situations, for many people, medications provide minimal or very temporary relief.

One problem with relieving sinus congestion is the anatomical structure of the sinuses. The frontal sinuses are disposed above the nasal cavity and drain downwardly into the nasal cavity adjacent the superior turbinate. Thus, the frontal sinuses are often relatively easy to clear and are often minor contributors to sinusitis pain. The maxillary sinuses, however are disposed below the eye. To drain fluid from the maxillary sinuses, the fluid must travel generally upward out of the maxillary sinus and into the middle meatus which opens in the nasal cavity between the middle turbinate and the inferior turbinate. Thus, the fluid in the sinus must initially move against gravity in order to be removed from the maxillary sinuses. Because of this, anti-histamines and nasal washes are often unable to clear the mucus from the sinus cavities.

Thus there is a need for an improved apparatus and method for relieving pain in sinus cavities. It is preferable that such an apparatus and method be relatively inexpensive and relatively easy to be performed without the supervision of medical personnel. Furthermore, it is desirable that such a method and apparatus be free from drugs which may interact with other medications which the person is taking.

### OBJECTS AND SUMMARY OF THE INVENTION

Thus it is an object of the present invention to provide an improved apparatus and method for relieving sinus pain and discomfort.

In accordance with the above and other principles of the invention, an apparatus for relieving sinus pain includes a body having a motor and a drive unit disposed therein. Operation of the motor moves the drive unit so as to create a vibrational force. The device may also preferably include an applicator configured for placing against the face of a user adjacent to a sinus cavity so that the applicator applies mechanical vibrations to the face.

In accordance with another aspect of the invention, the apparatus includes a power source, such as one or more batteries, and a control switch for selectively turning on and off the motor.

In accordance with the method of the present invention, mechanical vibration is applied to the face of the user adjacent to the sinuses. The application of the vibrational force relieves the pain associated with a sinus infection or other sinus congestion. It is believed that the method operates in several modalities. First, it is believed that the mechanical vibration helps to break up the mucus to thereby facilitate removal of the mucus from the sinuses of the user. Additionally, it is believed that the mechanical energy also causes vasodilatation in the blood vessels which feed the sinuses. The increased blood flow allows the better delivery of blood and white blood cells to the sinus cavity. Finally, the vibration produces a massaging effect on the sinuses and provides temporary relief of pain and discomfort.

According to one aspect of the invention, the applicator of the apparatus has a concave end. The concave end is designed to receive the skin immediately adjacent the zygomatic bone, the bone under the eye. Placing the apparatus adjacent the zygomatic bone and applying the vibrational energy increases comfort in a short period of time. The concave nature of the applicator helps to hold the apparatus in place despite the vibration.

### BRIEF DESCRIPTION OF THE DRAWINGS

The above and other objects, features and advantages of the invention will become apparent from a consideration of the following detailed description presented in connection with the accompanying drawings in which:

FIG. 1 shows a front view of a human head demonstrating the location of the frontal and maxillary sinuses;

FIG. 2 shows a see-through view of an apparatus for relieving sinus discomfort in accordance with principles of the present invention;

FIGS. 3A through 3E show top, front end, side, back end and bottom views, respectively of an apparatus formed in accordance with the principles of the present invention;

FIG. 4 shows a close-up view of an alternate applicator which is configured to provide heat and/or infrared radiation to the area being treated with vibration; and

FIGS. 5 and 6 show steps of a method for treating sinus discomfort in accordance with the principles of the present invention.

### DETAILED DESCRIPTION

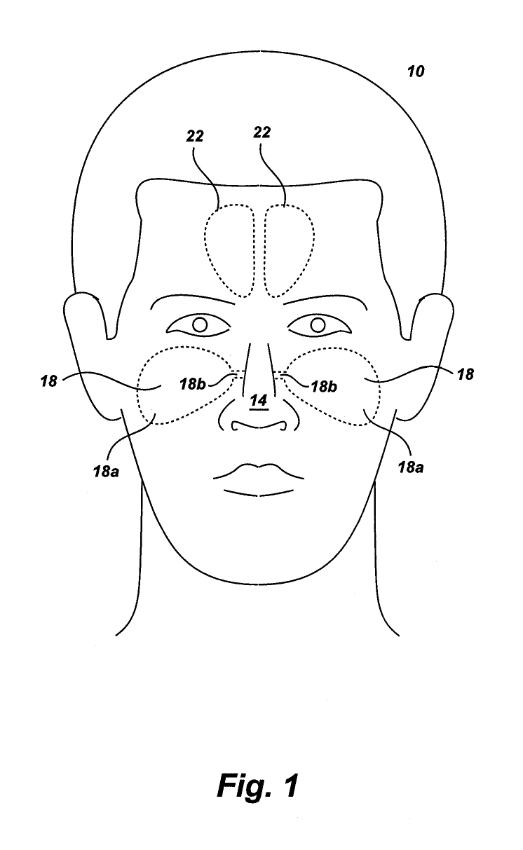

Turning now to FIG. 1 there is shown a front view of a human head, generally indicated at 10. Disposed on either side of the nose 14 are the maxillary sinuses, indicated at 18. The maxillary sinuses 18 form a pocket 18a and have an outlet 18b which is disposed substantially above most of the pocket. Thus, when the pocket 18a fills with mucus, it is difficult to get the sinuses to drain. This is especially so if the mucus thickens, as is common with many sinus infections, allergic reactions and certain types of colds and influenza.

The frontal sinuses 22, in contrast, are disposed above the nasal cavity and are better able to drain into the nasal cavity. However, even the frontal sinuses 22 can be irritated by bacteria, pollen, dust, etc. and can become congested. Applying vibrational energy to the frontal sinuses, such as by applying a vibrating device firmly against the skin adjacent the eyebrows will loosen the congestion and facilitate drainage. Additionally, it is believed that the vibration also causes vasodilatation of the blood vessels leading to the sinuses, thereby allowing the body's own defenses to work more efficiently and relieve the irritations.

In the case of the maxillary sinuses 18, the application of vibrational energy to the sinuses also helps to break up congestion and to increase blood flow to the sinus walls. This alone will provide temporary relief from sinus congestion. This can be improved by applying the vibrational energy with the head tipped to one side. Preferably the head is tipped to at least 45 degrees from vertical, and is more preferably disposed generally horizontal. The vibrational energy is then applied to the zygomatic bone adjacent the zygomatic maxillary suture, or other portions of the skull adjacent the sinuses. As the vibrational energy helps to loosen the mucus and reduce adherence to the sinus wall, the congestion is able to flow out the outlet 18b, where it passes into the nasal cavity and may be ejected by blowing the nose.

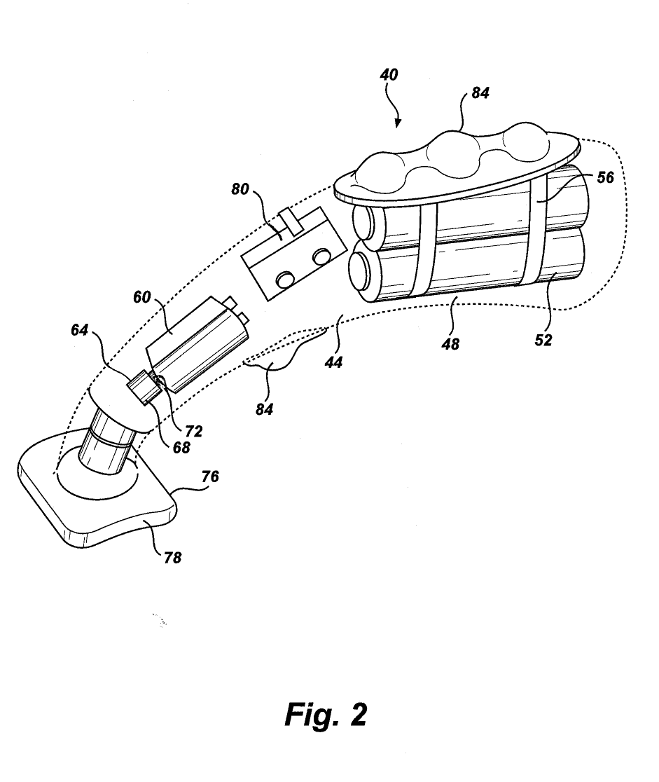

Turning now to FIG. 2 there is shown a see-through view of an apparatus, generally indicated at 40, made in accordance with the principle of the present invention. The apparatus 40 preferably includes a body 44 which forms a handle portion 48. The handle portion 48 may be any shape conveniently held by a human hand or held in some sort of retaining device. As shown in FIG. 2, the apparatus 40 is generally arcuate to make the apparatus easy to hold while applying vibration to the face of the user.

Disposed in the apparatus 40 is a power supply 52. The power supply 52 could be a power chord, but it is preferable that the power supply include a battery 56, either rechargeable or disposable, for ease of use. Other forms of power could also be used.

The power supply 52 is disposed in communication with a motor 60. (The connecting wires have been omitted for clarity, although the structures may be directly attached). The electricity from the power supply 52 drives the motor 60. The motor 60 may form, or may be attached to, a drive unit 64 to produce vibrational energy. Once simple method for generating vibrational energy is an offset element 68 which is carried on a drive shaft 72 so that rotation of the drive unit 64 creates vibrational energy. Other forms for producing vibrational energy may also be used.

The drive unit 64 may be disposed near or in communication with an applicator 76 which is applied to the user's face. The applicator 76 may be driven by the motor unit 64 to vibrate primarily the applicator 76, or the entire apparatus 40 may be caused to vibrate by the motor unit. As will be discussed in more detail below, the applicator 76 may be contoured, as shown at 78, so as to receive curvatures of the face to help hold the applicator in the desired location on the user's face. It is also preferred that the applicator have a relatively small surface area for engaging the face of the user. Thus, the applicator is preferably less than 3 square inches and more preferably less than two square inches so it only contacts the face immediately adjacent the afflicted sinus cavity.

The apparatus 40 also preferably includes a switch 80 for selectively stopping power to the motor 60. Any of a number of well known switches can be used.

The handle portion 48 may also include one or more contours, ridges 84 or other structures to facilitate gripping of the apparatus 40 while it is vibrating. Preferably, gripping structures, such as ridges 84 will be disposed on opposing sides of the handle to allow the user to hold the apparatus 40 in any comfortable position.

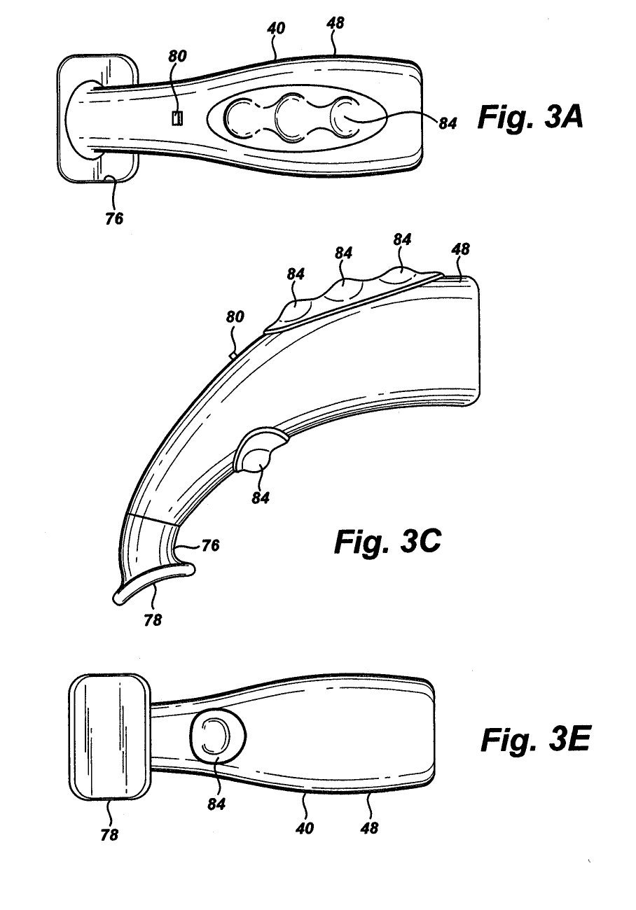

Turning now to FIGS. 3A through 3E, there are shown several different views of the apparatus 40. FIG. 3A shows a top view of the apparatus 40 and is numbered in accordance with the description in FIG. 2.

FIGS. 3B and 3D show front end and rear end views of the apparatus 40 so that the handle 48, contours or ridges 84 and applicator 76 are shown. FIG. 3B also shows the switch 80, while FIG. 3D shows the concave recess 78 in the applicator 76.

The recess 78 in the applicator 76 is best shown in FIGS. 3C and 3E. The underside of the applicator 76 is preferably provided with just enough curvature to conform to the curvature of the face adjacent the sinuses. This assists in the transfer of the vibrational energy and helps hold the applicator 76 in place during use.

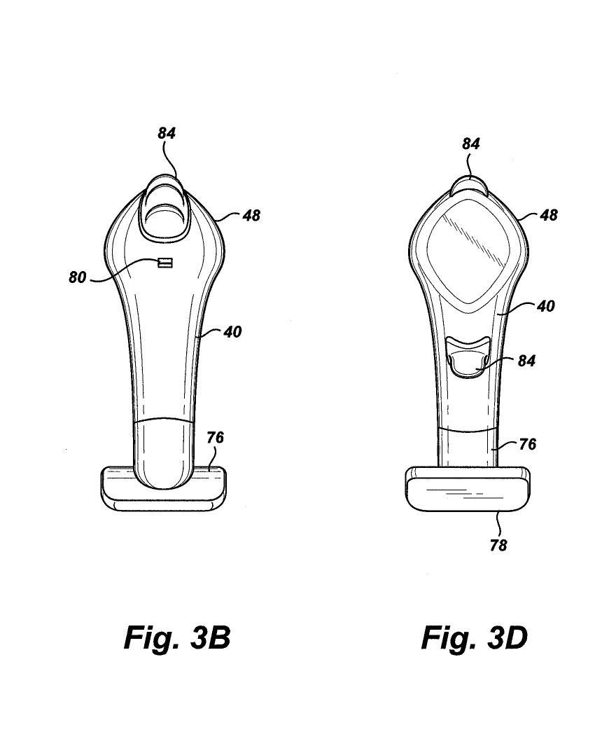

Turning now to FIG. 4, there is shown an alternate embodiment of an applicator portion 90. It will be appreciated that the applicator portion 90 may be formed integrally with the housing of the apparatus (such as apparatus 40). For simplicity, however, it is shown here as a removable element. It will also be understood that the applicator 90 may be used on the embodiment shown in FIGS. 2 through 3D in place of applicator 76 and that drawings showing such use have been omitted for brevity.

The applicator 90 includes a recess 94 for conforming to the face of the user. It will be appreciated that a recess 94 need not be provided, and that the applicator 90 may be formed from a flexible or elastomeric material so as to facilitate the applicator conforming to the shape of the user's face. The applicator 90 shown in FIG. 4 includes a heating element 98 which warms the applicator 90. The presence of heat also helps with vasodilatation and encourages increased blood flow to the sinuses. It also can provide a soothing effect which helps to alleviate the discomfort caused by the congested sinuses.

The applicator 90 also includes one or more infrared emitters 102. The infrared emitters help to generate heat within the tissues adjacent the sinuses, further increasing blood flow and reducing discomfort. The infrared emitters 102 may be disposed in any desired pattern.

The applicator 90 may also include other devices for increasing vasodilatation and/or the breaking up of congestion. Thus, for example, one or more ultrasound emitters 104 may also be used to apply ultrasound to the afflicted sinus cavity.

Also shown in FIG. 4 is a power line 106. The power line can be configured to provide power to the heating element 98, the infrared emitter(s) 102, and/or the ultrasound emitter(s) 104. The power line 106 will typically be disposed in communication with the switch 80 (FIGS. 2, 3A-3C) so that power is provided by the power supply 52 only when the motor 60 is running. In the alternative, a three-way or multifunction switch could be used to allow the heating element 98, the infrared emitter(s) 102 and/or ultrasound emitter(s) 104 to operate independent of the motor unit. Thus, the user could apply heat without the application of vibration and vice versa.

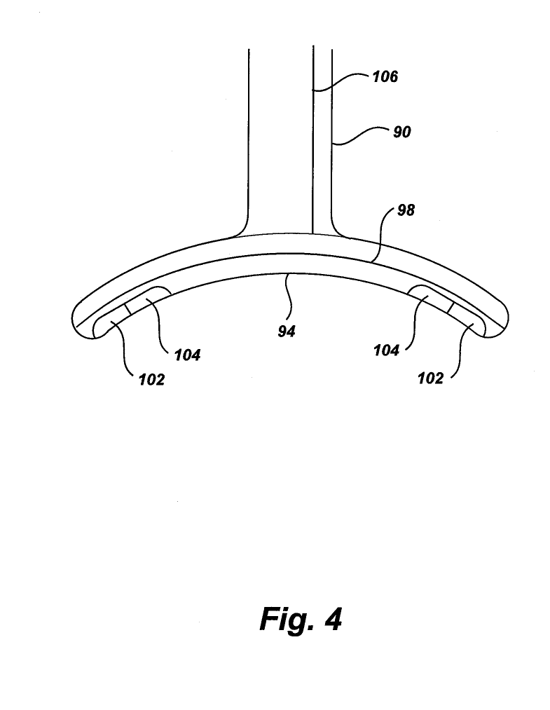

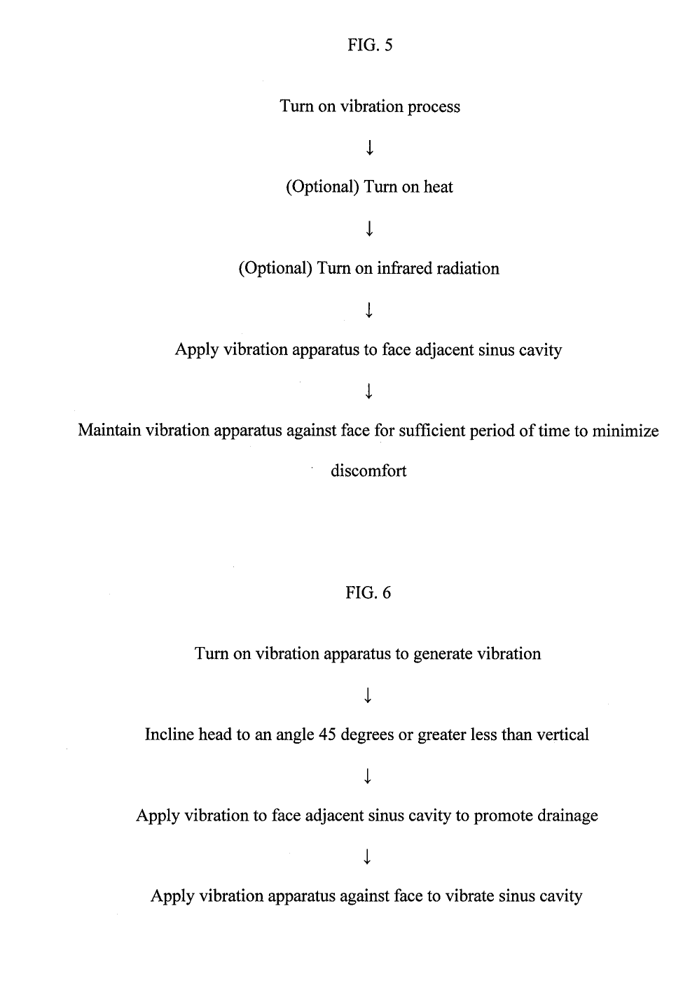

FIGS. 5 and 6 show methods of using a vibrating device to relieve sinus pain or discomfort. It will be appreciated that additional steps may be included if the vibration device is provided with a heating element and/or an infrared emitter. Additionally, it will be appreciated that the method steps in FIGS. 5 and 6 are exemplary and are not intended to limit the claims. Additionally, it will be appreciated that the steps shown in FIGS. 5 and 6 may be performed in other than the listed order.

Thus there is disclosed an apparatus and method for relieving sinus pain or discomfort. Those skilled in the art will appreciate numerous modifications which may be made to either the apparatus or method based on the teachings of the present invention. The appended claims are intended to cover such modifications.

What is claimed is:

1. A method for relieving sinus discomfort in an afflicted sinus cavity of a person comprising:
selecting a vibration device; and
applying vibrational energy to the head of the person adjacent the afflicted sinus cavity.

2. The method according to claim 1, wherein the method further comprises applying heat to the head of the person adjacent to the afflicted sinus cavity.

3. The method according to claim 1, wherein the method further comprises applying infrared radiation to the head of the person adjacent to the afflicted sinus cavity.

4. The method according to claim 1, wherein the method comprising applying the vibrational energy while the person's head is disposed at an incline at least 45 degrees less than vertical.

5. The method according to claim 4, wherein the method comprises applying vibrational energy to the person's head while the head is substantially horizontal.

6. The method according to claim 1, wherein the method further comprises applying ultrasound to the face while applying vibration.

7. The method according to claim 1, further comprising using a curved applicator to apply vibration to the head of the person adjacent the afflicted sinus cavity.

8. An apparatus for relieving sinus discomfort, the apparatus comprising:
a power supply comprising at least one battery;
a motor unit disposed in communication with a power supply, the motor unit receiving power from the power supply; and
an applicator, the applicator configured for applying vibrational energy to a portion of the head of a user.

9. The apparatus of claim 8, wherein the apparatus further comprises a body for holding the power supply and the motor unit, the body comprising a handle portion having a plurality of ridges disposed thereon.

10. The apparatus of claim 8, wherein the applicator comprises an applicator having a concave recess configured to conform to a portion of a user's face.

11. The apparatus of claim 8, wherein the applicator comprises a heating element.

12. The apparatus of claim 8, wherein the applicator comprises at least one infrared emitter.

13. The apparatus of claim 11, wherein the applicator has a surface area of less than two square inches.

14. The apparatus of claim 8, wherein the applicator comprises at least one ultrasound emitter.

15. The apparatus of claim 8, wherein the apparatus is generally arcuate.

16. An apparatus for relieving sinus discomfort, the apparatus comprising:
a power supply comprising at least one battery;
a motor unit disposed in communication with a power supply, the motor unit receiving power from the power supply; and
an applicator, the applicator configured for applying vibrational energy to a portion of the head of a user, the applicator having an arcuate portion sized to receive the zygomatic bone of a user's face.

17. The apparatus of claim 16, wherein the applicator comprises a heating element.

18. The apparatus of claim 16, wherein the applicator comprises at least one infrared emitter.

18. The apparatus of claim 18, wherein the applicator has a surface area of less than two square inches.

20. The apparatus of claim 16, wherein the applicator comprises at least one ultrasound emitter.
